(19) United States
(12) Patent Application Publication
(10) Pub. No.: US 2015/0149745 A1
(43) Pub. Date: May 28, 2015

(54) PARALLELIZATION WITH CONTROLLED DATA SHARING

(71) Applicants: Markus Eble, Walldorf (DE); Vaidas Gasiunas, Hemsbach (DE); Ivan Galkin, Karlsruhe (DE); Maciej Kabala, Reilingen (DE); Arne Harren, Walldorf (DE); Klaus Kretzschmar, Angelbachtal (DE); Tobias Elfner, Schriesheim (DE); Philipp Becker, Eisenberg (DE)

(72) Inventors: Markus Eble, Walldorf (DE); Vaidas Gasiunas, Hemsbach (DE); Ivan Galkin, Karlsruhe (DE); Maciej Kabala, Reilingen (DE); Arne Harren, Walldorf (DE); Klaus Kretzschmar, Angelbachtal (DE); Tobias Elfner, Schriesheim (DE); Philipp Becker, Eisenberg (DE)

(21) Appl. No.: 14/245,643

(22) Filed: Apr. 4, 2014

Related U.S. Application Data
(60) Provisional application No. 61/908,541, filed on Nov. 25, 2013.

(51) Int. Cl. G06F 9/38

(52) U.S. Cl. CPC G06F 9/3838
USPC 712/216

(57) ABSTRACT

In one general aspect, a method can include executing multiple functions calls in parallel, and receiving, by each function call, at least one data object passed as a parameter to the function call, the at least one data object associated with a data sharing mode that defines a restricted subset of allowed operations for performing by the function call on the at least one data object. The method can further include performing, by each function call, at least one operation on the at least one data object, the at least one operation included in the restricted subset of allowed operations, and performing at least one check to ensure that the at least one operation performed by the function call on the at least one data object received by the function call is included in the restricted subset of allowed operations.

### CROSS-REFERENCE TO RELATED APPLICATIONS

This application claims priority under 35 U.S.C. §119(e)(1), to U.S. Provisional Application Ser. No. 61/908,541, filed on Nov. 25, 2013, the entire contents of which are incorporated herein.

### TECHNICAL FIELD

This description relates to systems and techniques for data sharing in parallel processing.

### BACKGROUND

Conventional parallel programming approaches used in popular programming languages (e.g., C++, Java, Python) can be based on a shared-memory parallelization model. The shared memory parallelization model may be prone to error situations such as race conditions or deadlocks. In particular, a race condition, i.e., changing the same data in a computing system concurrently, can be dangerous because it may lead to memory corruption and consequently to a crash or undefined behavior of the computing system. In these conventional approaches, it is the responsibility of a program developer to implement a computer program in such a manner that these errors are avoided. In some implementations, when using a database programming language, programs can be written while a database is in active use, and therefore errors in the database program can result in a database user accidentally or, in some cases, maliciously producing a database crash.

In some cases, a computer program can be implemented such that race conditions can be eliminated by imposing strict limitations on a programming model. For example, functional programming can ensure safer parallelization by limiting access to shared memory to immutable data only. In another example, message-passing models can avoid race conditions by prohibiting data sharing.

In the context of databases, for example, safer parallelization may be ensured by locking access to all shared data, in effect limiting parallelization and data sharing. When data sharing is limited, more of the data may need to be copied. Copying data can be problematic when processing large amounts of data and data locking can be expensive. These performance penalties can result in limiting the potential for a computer system speed-up and scalability of the parallelization.

### SUMMARY

In one general aspect, a method for data sharing by parallel function calls includes creating a view of an original object, the view associated with the original object, associating a restricted subset of allowed operations for performing on elements and/or properties of the original object with the view of the original object, and allowing a first parallel function call of the parallel function calls to perform one or more operations to the elements and/or the properties of the original object based on the restricted subset of allowed operations associated with the view of the original object.

In another general aspect, a method includes executing multiple functions calls in parallel, receiving, by each function call, at least one data object passed as a parameter to the function call, the at least one data object associated with a data sharing mode that defines a restricted subset of allowed operations for performing by the function call on the at least one data object, performing, by each function call, at least one operation on the at least one data object received by the function call, the at least one operation included in the restricted subset of allowed operations defined by the data sharing mode associated with the at least one data object, and performing at least one check to ensure that the at least one operation performed by the function call on the at least one data object received by the function call is included in the restricted subset of allowed operations defined by the data sharing mode associated with the at least one data object.

In yet another general aspect, a computing system includes one or more processors, and a computer-readable medium coupled to the computing system having instructions stored thereon which, when executed by the one or more processors, cause the one or more processors to perform operations including executing multiple functions calls in parallel, receiving, by each function call, at least one data object passed as a parameter to the function call, the at least one data object associated with a data sharing mode that defines a restricted subset of allowed operations for performing by the function call on the at least one data object, performing, by each function call, at least one operation on the at least one data object received by the function call, the at least one operation included in the restricted subset of allowed operations defined by the data sharing mode associated with the at least one data object, and performing at least one check to ensure that the at least one operation performed by the function call on the at least one data object received by the function call is included in the restricted subset of allowed operations defined by the data sharing mode associated with the at least one data object.

Example implementations may include one or more of the following features or combinations thereof. For instance, the data sharing mode can be one of an exclusive access level, a shared read access level, and shared container write access level. The data sharing mode can be the exclusive access level, and the restricted subset of allowed operations can include a read operation and a write operation. The data sharing mode can be the shared read access level, and the restricted subset of allowed operations can include a read operation. The data sharing mode can be the shared container write access level, and the restricted subset of allowed operations can include a container write operation and a metadata read operation. The at least one data object passed as a parameter to the function call can be initialized during the passing of the parameter. The operations further include creating a quantity of data partitions, creating multiple instances of a worker function, and associating each instance of the worker function with a respective different one of the quantity of data partitions, where executing multiple functions calls in parallel can include executing the multiple instances of the worker functions in parallel. The operation of receiving, by each function call, at least one data object passed as a parameter to the function call can include receiving, by each instance of the worker function, the at least one data object passed as a parameter to the instance of the worker function from the data partition associated with the instance of the worker function. The operation of performing at least one check can include performing an aliasing check, the aliasing check being one of a runtime check or a compile-time optimization. The operation of performing the aliasing checking can include checking an alias type associated with an alias, the alias type being one of a value type, an atomic reference type, a composite type, and a hidden type.

The details of one or more implementations are set forth in the accompanying drawings and the description below. Other features will be apparent from the description and drawings, and from the claims.

### BRIEF DESCRIPTION OF THE DRAWINGS

FIG. 1 illustrates an example system that can execute implementations of the present disclosure.

FIG. 2 is a block diagram that illustrates the use of implicit constructions and explicit constructions using view modifiers.

FIG. 3 is an example block diagram showing an example usage of data sharing and parallelization.

FIG. 4 is a block diagram showing an example data filtering process that uses partitioning and data sharing along with parallelization to perform the process.

FIG. 5 is a block diagram showing an example process for pairwise summing of elements in a first data block and a second data block that uses partitioning and data sharing along with parallelization to perform the process.

FIG. 6 is a flowchart that illustrates a method for implementing data partitioning and sharing along with parallelization.

FIG. 7 is a flowchart that illustrates a method for implementing data sharing along with parallelization.

Like reference symbols in the various drawings indicate like elements.

### DETAILED DESCRIPTION

In some implementations, a computing system can include programming code that can provide safe, scalable, and easy to use parallelization. Parallelization can be achieved by implementing programming code that can be executed by one or more processors or processing systems in parallel. The scalability can be achieved by providing safe data-sharing without locks. A programming language can be used to implement compile-time and runtime checks that can rule out the possibility of unsafe race conditions. The possibility of these checks can be enabled in the computing system by controlling aliasing of data in a runtime model of the programming language and by implementing data sharing annotations.

A programmer using the programming language can create programming code that implements parallel processing and that declares a degree of desired sharing (sharing rules) for data used in the parallel processing. For example, each processor can execute code that can access one or more data partitions assigned to (associated with) the particular processor. The programming code can check that the sharing rules are obeyed. In addition or in the alternative, the programming code can ensure that no memory is shared between parallel tasks in order to avoid unsafe race conditions or other types of conditions that could possibly compromise the stored data.

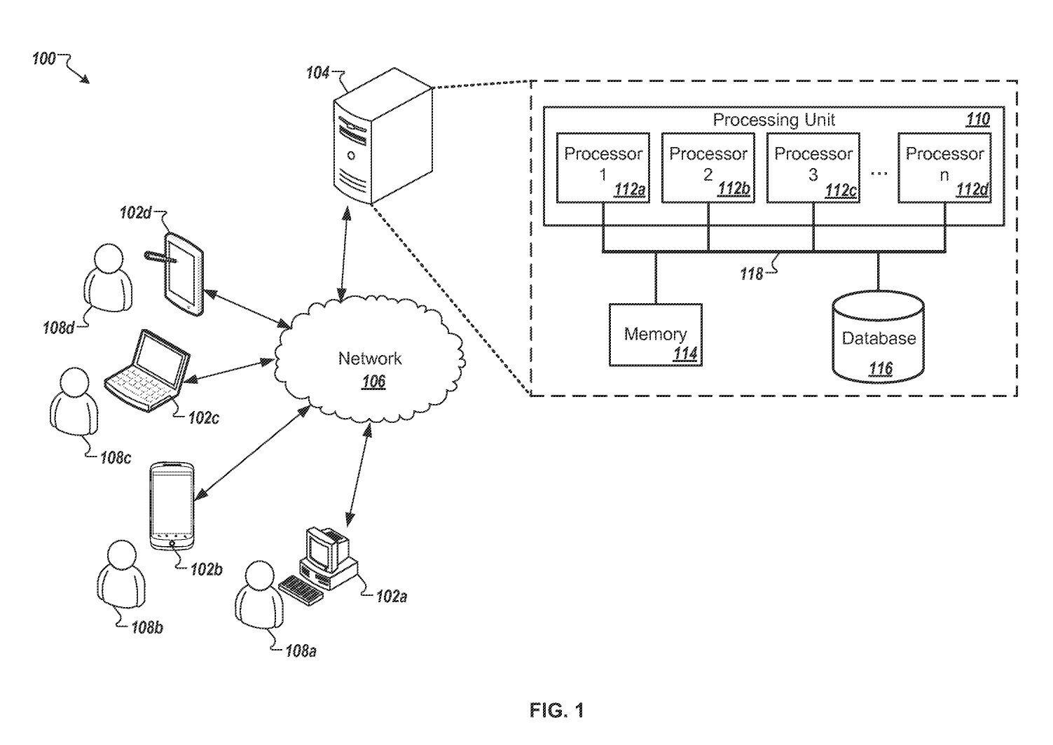

FIG. 1 illustrates an example system 100 that can execute implementations of the present disclosure. The example system 100 includes example computing devices 102a-d, a computing system 104, and a network 106. The computing devices 102a-d and the computing system 104 can communicate over the network 106.

The computing devices 102a-d can each be operated by users 108a-d, respectively. As shown in FIG. 1, the computing system 104 includes a processing unit 110 that includes processors 112a-d (Processor 1 to Processor n, where n>=4). In addition, the computing system 104 includes memory 114 and a database 116. The processors 112a-d, the memory 114, and the database can be connected and communicate with one another using a bus 118.

The example system 100 includes four processors (processors 112a-d), however, in some implementations the system 100 can includes less than four processors (e.g., one, two, or three processors) or more than four processors. In some implementations, the database 116 can be external to the computing system 104. In some implementations, the database 116 can be an in-memory database included in the memory 114. In some implementations, the system 100 can include multiple computing systems similar to the computing system 104, where each computing system can communicate over the network 106 with the computing devices 102a-d.

For example, as shown in FIG. 1, the computing devices 102a-d can be a desktop computer, a smartphone, a laptop computer, and a tablet computer, respectively. Other example computing devices can include but are not limited to smartphones, personal digital assistants, portable media players, or other appropriate computing devices that can be used to communicate with the computing system 104 using the network 106. In some implementations, the computing devices 102a-d can perform client-side operations, as discussed in further detail herein. In some implementations, the computing system 104 can include one or more computing devices such as a computer server. In some implementations, the computing system 104 can represent more than one computing device working together to perform server-side operations, as discussed in further detail herein. In some implementations, the network 106 can be a public communication network (e.g., the Internet, cellular data network, dialup modems over a telephone network) or a private communications network (e.g., private LAN, leased lines).

For example, referring to FIG. 1, a programmer can create programming code. For example, a user 108a can interface with computing device 102a to create programming code that can be executed by the computing system 104. The programming code can access a database (e.g., database 116) of customers for an enterprise to determine which customers are located in New York State. The computing system 104 can execute the programming code using multiple processors (e.g., processors 112a-d) that can operate in parallel to execute the programming code. The programming code can declare that an input sharing rule for the database be a shared read rule. In addition, the programming code can declare that an output sharing rule for the database be a shared write rule. The database 116 can be partitioned such that each of the processors 112a-d can access (read) a unique one-fourth of the database. The results determined by each processor 112a-d (how many of the customers included in the particular one-fourth of the database 116 accessed and read by the particular processor 112a-d) can be output (written) and merged to determine a total number of customers included in the database 116 that are located in New York State.

In some implementations, the L programming language can be the programming language used to implement compile-time and runtime checks that can rule out the possibility of unsafe race conditions. Using the L programming language, a programmer can create programming code that specifies a degree of desired sharing (sharing rules) for data used in parallel processing. The L programming language is a programming language that can be used for implementing user-defined data processing. The implementations can take the form of one or more stored procedures or user-defined functions. L programs can be used directly in or can be generated out of higher-level database languages, such as from a Structured Query Language (SQL) script. For example, an SQL script can be a set of Structured Query Language (SQL) commands or statements, and/or Procedural Language/Structured Query Language (PL/SQL) blocks. New L programs can be written and introduced into a database during the use of the database. As such, it is important that the L programs be safe, because an error in an L program may cause a crash in the database process. For example, when an in-memory database (e.g., HANA by SAP®) is used, a crash in a database process can result in a loss of data and a possible system security problem.

The data sharing and parallelization can be implemented, for example, in three levels or modes. A first level or mode can be referred to as an exclusive access level. At this level of data sharing, input data provided to parallel tasks can be provided as deep copies or as unique input data references. For example, a deep copy can include a copy of each element of a database object, essentially creating a new copy of the database object. At the exclusive access level, memory (e.g., memory local to a processor) for output data can be provided as a unique output data reference. Data sharing and parallelization performed at the exclusive access level can ensure that parallel tasks do not interfere with each other. In addition, data sharing and parallelization performed at the exclusive access level can ensure that data used by a particular task is used only by the particular task. As such, the data output by the parallel task can be stored in the memory at the unique output data reference. At the exclusive access level, a parallel function call has full access (e.g., read access and write access) to input data and output data provided to the parallel function call. A parallel function call can perform a read operation using the unique input data reference and/or can perform a write operation using the unique output data reference.

A second level or mode of data sharing and parallelization can be referred to as a shared read access level. The shared read access level can be directed at data sharing and parallelization of input data. In addition to the first or exclusive access level, in the second or shared read access level, input data provided to parallel tasks can be provided as a read-only reference. Data sharing and parallelization performed at the shared read access level could allow two or more parallel tasks to share the input data at a same read-only reference, while ensuring that the two or more parallel tasks do not have a writeable reference to the input data. Each parallel task can perform a read operation using the read-only reference. Data sharing and parallelization performed at the shared read access level could ensure that the two or more parallel tasks do not interfere with each other. As compared to data sharing and parallelization performed at the exclusive access level, data sharing and parallelization performed at the shared read access level could avoid the need for deep copies (making copies) of the input data by allowing the two or more parallel tasks to share the same read-only reference to the input data. In cases where the input data is large, not needing to make copies can reduce the amount of memory required in a computing system.

A third level or mode of data sharing and parallelization can be referred to as a shared container write access level. In addition to the shared read access level, in the third or shared container write access level, output data provided by parallel tasks can be provided as a container-write reference. For example, a container (e.g., a data partition) can include a structured set of one or more database objects (data objects). The container can have associated metadata (e.g., a size of the container). The container can be a specific size based on the number of database objects included in the container. Each database object can include one or more data elements. One or more properties can be associated with each database object. In a container-write operation, write operations to container objects are allowed, but changes to the structure or properties of the container (e.g. resizing) are not allowed. Data sharing and parallelization performed at the shared container write access level can allow two or more parallel tasks to share the same container through a container-write reference. Each parallel task can perform a write operation to a container object using the container-write reference and/or can read metadata associated with the container.

Data sharing and parallelization performed at the shared container write access level can ensure that none of the parallel tasks has a read-only or otherwise unique reference to the shared container. As such, data sharing and parallelization performed at the shared container write access level can ensure that parallel access to the container does not lead to system crashes. In addition, data sharing and parallelization performed at the shared container write access level can ensure that the two or more parallel tasks do not interfere with each other, as long as each of the two or more parallel tasks access separate parts of the shared container, which is the intended use of the shared container write access level. The container-write operations can be implemented such that even if a developer were to implement code that, intentionally or unintentionally, writes concurrently to the same part of the shared container, the worst case scenario would cause indeterministic results in that part of the container. The intentional or unintentional concurrent writes to the same part of the shared container may not result in crashing the computing system (e.g., computing system 104) or corrupting the memory (e.g., memory 114) and/or database (e.g., database 116) in the computing system.

In some implementations, an additional level of data sharing and parallelization can be referred to as a shared-read-write access level. The shared-read-write access level can be a combination of the shared read access level and the shared container write access level. The shared-read-write access level can support all read operations as described for the shared read access level and all container-write operations as described for the shared container write access level. The shared-read-write access level includes data safeguards analogous to those of the container write access level.

For all of the levels of data sharing and parallelization described (the exclusive access level, the shared read access level and the shared container write access level), input and output data can be checked at compile-time and runtime of the programming code to ensure that the data sharing and parallelization performed at each level is being performed properly. For example, if the programmed code attempts to pass the same data as a unique input reference to two different parallel tasks, an error message is provided and the execution of the parallel tasks is not started. The error message is a result of the passing of the same data as a unique input reference to two different parallel tasks violating the data sharing and parallelization implemented at the exclusive access level.

Implementing data sharing and parallelization in the levels as described can identify and avoid programming errors that could cause a crash or deadlock of a computing system. In addition, implementing data sharing and parallelization in the levels as described results in eliminating the need to lock and unlock data in order to provide shared access to the data by parallel tasks. The elimination of data locking results in the elimination of synchronization bottlenecks allowing the programming code to make full use of the available hardware resources, allowing for scalability.

When used to implement data sharing and parallelization, the L programming language can provide safe low-level programming code language constructs which can be used by the low-level programming code to exploit intra-node parallelization. The use of L programming code can provide multiple mechanisms for data sharing and parallelization. A first mechanism for data sharing and parallelization can be a parallel scope where multiple, possibly different function calls are run in parallel. A second mechanism can be dynamic partitioning where the same function is run on multiple partitions of a large data set in parallel. For example, a task can be executed on a large amount of data as several independent tasks working in parallel, where each task works on a partition of data (e.g., calculate a sum, join, perform matrix multiplication).

The use of L programming code to provide for multiple mechanisms for data sharing and parallelization can ensure a safe and efficient programming construct. For example, regarding safety, typical errors which may occur in a parallel execution context can be avoided or detected and reported at compile-time or runtime. Specifically, for a parallel execution (two or more tasks running in parallel), technical race conditions and the possibility of deadlocks can be (structurally) avoided. In addition, the efficient programming construct of the L programming code (e.g., the overhead related to data sharing and parallelization) can be such that the need and cost of data synchronization, and the need (and associated memory cost) to copy data can be minimized.

Parallel execution of a statically known set of function calls can be expressed by a parallel scope. A parallel scope can be an anonymous scope, which is marked with a “_parallel” modifier. A parallel scope can include function calls. Table 1 is an example of programming code that can implement a parallel scope.

TABLE 1

| | |
|---|---|
| (1) | Void f(Int32 fa, Int32 & fb) { |

| | |
|---|---|
| (2) | fb = ... |

| | |
|---|---|
| (3) | } |
| (4) | Void g(Int32 gc, Int32 & gd) { |

| | |
|---|---|
| (5) | gd = ... |

| | |
|---|---|
| (6) | } |
| (7) | Void h( ) { |

| | |
|---|---|
| (8) | ... |
| (9) | Int32 a; |
| (10) | Int32 b; |
| (11) | Int32 c; |
| (12) | Int32 d; |
| (13) | ... |
| (14) | _parallel { |

| | |
|---|---|
| (15) | f(2*a, b); |
| (16) | g(3*c, d); |

| | |
|---|---|
| (17) | } |

| | |
|---|---|
| (18) | ... |
| (19) | } |

For example, referring to Table 1 line (7), inside the h( ) function, the h( ) function calls a function f(2*a, b) (see Table 1, line (15)) and a function g(3*c, d) (see Table 1, line (16)). The function f(2*a, b) and the function g(3*c, d) can be (semantically) executed in parallel. The result of the call to the function f(2*a, b) and the result of the call to the function g(3*c, d) can be stored in the local variables b and d, respectively. The execution order of the function f(2*a, b) and the function g(3*c, d) can be non-deterministic. For example, the call to the function g(3*c, d) may be started before the call to the function f(2*a, b). For example, the call to the function f(2*a, b) may be started before the call to the function g(3*c, d). In the alternative, the function f(2*a, b) and the function g(3*c, d) may be called sequentially due to resource limitations of the runtime.

In contrast to the non-determinism of the function calls, all parameter expressions can be evaluated in a deterministic way before the occurrence of the parallel function calls. In the example shown in Table 1, the parameter expression “2*a” (see Table 1, line (15)) is evaluated, followed by the evaluation of the parameter expression “3*c” (see Table 1, line (16)), followed by the parallel calls to the function f(2*a, b) and the function g(3*c, d). Table 2 below shows the equivalent pseudocode for the code shown in Table 1.

TABLE 2

| | |
|---|---|
| (1) | Int32 _temp1 = 2*a; |
| (2) | Int32 _temp2 = 3*c; |

| | |
|---|---|
| (3) | _parallel { |

| | |
|---|---|
| (4) | f(_temp1, b); |
| (5) | g(_temp2, d); |

| | |
|---|---|
| (6) | } |

Dynamic partitioning can allow a function to be invoked multiple times on multiple partitions of data. Dynamic partitioning can be parameterized by a partitioning configuration, a worker function, and by input and output parameters as shown in an example of programming code in Table 3, below.

TABLE 3

| | |
|---|---|
| (1) | Void f(Block<Int32> fa, Int32 & fb, PartitionInfo info) { |

| | |
|---|---|
| (2) | fb = ...; |

| | |
|---|---|
| (3) | } |
| (4) | Void h( ) { |

| | |
|---|---|
| (5) | ... |
| (6) | Block<Int32> a = ...; |
| (7) | Block<Int32> b; |
| (8) | ... |
| (9) | PartitionConfig config = ...; |
| (10) | parallel::partitionedInvoke(config, f, a, b); |
| (11) | ... |

| | |
|---|---|
| (12) | } |

The partitioning configuration can define a number of partitions to be created. The number of partitions can be specified precisely, can be limited by a maximum value, or can be omitted. In the case where the number of partitions is omitted, the execution framework (e.g., a parallelization framework) can determine the number of partitions based on a recommended level of parallelization of the runtime environment.

A worker function can be called once for each partition. The worker function can receive a partitioning information parameter that includes information about the current partition index and information about a total number of partitions (e.g., the partitioning information parameter specifies that the current partition is partition one of a total of 10 partitions). Table 4 below shows example programming code that implements a worker function.

TABLE 4

| | |
|---|---|
| (1) | Void worker(..., PartitionInfo information){ |

| | |
|---|---|
| (2) | Size myNumber = information.getPartitionIndex( ); |
| (3) | Size totalNumber = information.getPartitionCount( ); |

(4)

| | |
|---|---|
| (5) | // a) calculate bounds for input/output containers |
| (6) | // b) extract pre-calculated bounds from shared input arguments |

(7)

| | |
|---|---|
| (8) | // do something useful |

| | |
|---|---|
| (9) | } |

In addition, each worker function can receive its own (deep) copy of a private input argument and a shared input argument. The shared input argument can be used by all worker functions that process the same object. Each worker function can provide a private output argument in the cases where each worker function produces its own result. The programming code can implicitly merge all results once the parallel execution of the functions is complete. Each worker function can provide a shared output argument used by all worker functions that process the same object.

In order to allow efficient and safe sharing of data structures among functions that run in parallel, object views can restrict an available set of allowed operations on original objects. Object views can allow the passing of an object or parts of the object to parallel function calls without the need to create private deep copies of each object for each parallel task. For example, a _shared_read view of an object allows read-only access to the (container) properties of the original object and read-only access to the (container) data elements of the original object. For example, a _shared_write view of an object allows read-only access to the (container) properties of the original object and write-only access to the (container) elements of the original object. In this example, the (container) elements cannot be read using a _shared_write view only written. For example, a _shared_readwrite view of an object allows read-only access to the (container) properties of the original object and read/write access to the (container) elements of the original object.

In these examples, object views with write access (e.g., the _shared_write view and the _shared_readwrite view) can prevent object manipulations that are considered unsafe when an update or read operation is performed by functions that are running in parallel. For example, the object manipulations that may be considered unsafe can include modifications of particular container properties such as the container size or a re-assigning of the container components. While these object manipulations may not be possible using an object view, an object manipulation may be possible using an aliased reference (a reference using another variable that points to the same object).

Changes made to an object are visible through the view of the object. As such, deep copies of the object are not needed. To ensure that dangling pointers do not occur, object views keep the original object active (alive). The _shared_read view, the _shared_write view, and the _shared_readwrite view ensure that concurrent tasks cannot manipulate the structure of an object. The _shared_read view, the _shared_write view, and the _shared_readwrite view can prevent technical race conditions from occurring, ensuring that concurrent changes made to the data of an object do not lead to an inconsistent object state.

When using parallel function calls, aliasing of objects with different or no modifiers (i.e., unconstrained access) may not be permitted. For example, an object cannot be passed as a _shared_read view of the object and as a full-access object at the same time. In this case, the object properties of the _shared_read view of the full-access object may not be guaranteed. When using parallel function calls, if a container type is passed to a first function call as a normal object, any of the objects inside the container object may not also be passed to a parallel second function call as a separate _shared_read parameter. This restriction, however, applies to parameters that are passed to functions only when the functions are executed in parallel. In another example, a second function can accept any of the objects inside the container object when the second function is not called in parallel with the first function.

The L programming language can include view modifiers. In some implementations, one or more view modifiers can be used to mark an object, which is reachable using a local variable or a function parameter, or to mark an object being returned from a function as a view of the object. Table 5 below shows an example of programming code that can include view modifiers.

TABLE 5

| | |
|---|---|
| (1) | Void f(_shared_read T p) { |

| | |
|---|---|
| (2) | ... |

| | |
|---|---|
| (3) | } |
| (4) | Void g( ) { |

| | |
|---|---|
| (5) | ... |
| (6) | _shared_read T x = ...; |
| (7) | ... |

| | |
|---|---|
| (8) | } |
| (9) | _shared_read T h( ) { |

| | |
|---|---|
| (10) | ... |
| (11) | return ...; |

| | |
|---|---|
| (12) | } |

Table 6 below includes example L programming code for a construction of object views.

TABLE 6

| | |
|---|---|
| (1) | Block<T> plainBlock = ...; |
| (2) | _shared_read Block<T> readBlock; |
| (3) | _shared_write Block<T> writeBlock; |
| (4) | |
| (5) | // implicit view construction |
| (6) | writeBlock = plainBlock; |
| (7) | readBlock = plainBlock; |
| (8) | readBlock = writeBlock; |
| (9) | |
| (10) | // explicit construction of new object from view |
| (11) | plainBlock = Block<T>(readBlock); |
| (12) | plainBlock = Block<T>(writeBlock); |
| (13) | |
| (14) | // function calls |
| (15) | Void f(_shared_read Block<T> readBlock) {...} |
| (16) | Void main( ) { |

| | |
|---|---|
| (17) | Block<T> plainBlock = ...; |
| (18) | f(plainBlock); // implicit view construction for function call |

| | |
|---|---|
| (19) | } |

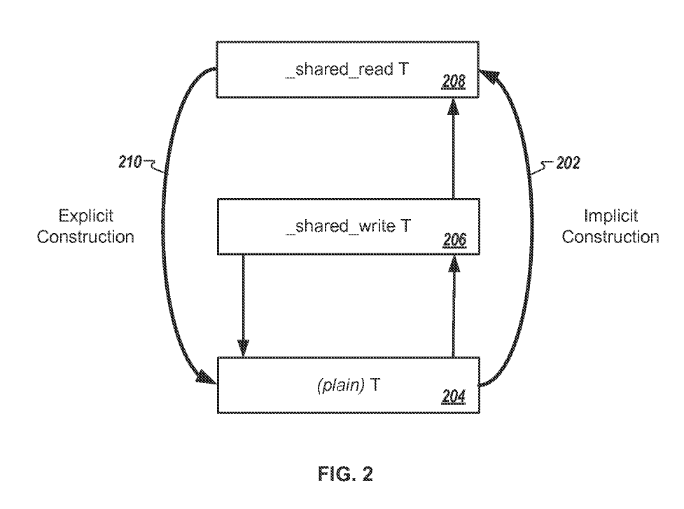

FIG. 2 is a block diagram that illustrates the use of implicit constructions and explicit constructions using view modifiers. An implicit view construction 202 (example programming code shown in Table 5, lines 5-8) can define an implicit view constriction of one or more objects in a data block T from a (plain) T view 204 (the base or original object) to a _shared_write T view 206 of the object and to a _shared_read T view 208 of the object. In addition, the implicit view construction 202 can create an implicit view constriction of the _shared_write T view 206 of the object to a _shared_read T view 208 of the object.

Explicit construction 210 of a new object from the object view (example programming code shown in Table 5, lines 10-12) can define an explicit view constriction of a new object from the _shared_read T view 208 of the object to a (plain) T view 204 of the object and can define an explicit view construction of a new object from the _shared_write T view 206 of the object to the (plain) T view 204 of the object.

In some implementations, view modifiers can propagate to inner types of container/structured objects in order to represent a deep _shared_read view/_shared_write view behaviour of the objects. For example, once a component from a _shared_read parameter is retrieved, the component itself may also be considered a type of a _shared_read. Table 7 shows an example of programming code that can implement the propagation of view modifiers to inner types of container/structured objects.

TABLE 7

| | |
|---|---|
| (1) | _shared_read Table<Int32 “A”> table; |
| (2) | // table.“A” returns an object of type ‘_shared_read Column<Int32>’ |
| (3) | |
| (4) | _shared_read Tuple<Column<Int32> “B”> tuple; |
| (5) | // tuple.“B” returns an object of type ‘_shared_read Column<Int32>’ |
| (6) | |
| (7) | _shared_read Tuple<Block<Int32> “C”> tuple; |
| (8) | // tuple.“C” returns an object of type ‘_shared_read Block<Int32>’ |

In some implementations, as shown in the example programming code in Table 8 below, view modifiers may not propagate to and are not valid (and meaningful) for some scalar data value types (e.g. Bool, Int32, String, etc). This is because objects that are of these scalar data value types are typically passed by value and modified as a whole. There is little practical use, therefore, in having shared references to these scalar data value types. Examples of valid data value types that view modifiers are applicable for include, but are not limited to, Table, Column, Block and Tuple. These valid data value types can describe relatively large objects that can be passed by reference to avoid having to make a copy of them in memory.

TABLE 8

| | |
|---|---|
| (1) | _shared_read Table<Int32 “A”> table; |
| (2) | _shared_read Column<Int32> column = table.“A”; |
| (3) | // Column[0z] returns an object of type ‘Int32’, |
| | not ‘_shared_read Int32’ |
| (4) | _shared_read Tuple<Int32 “B”> tuple; |
| (5) | // tuple.“B” returns an object of type ‘Int32’, |
| | not ‘_shared_read Int32’ |

In some implementations, view modifiers may not propagate to and may not be valid for inner types of container/structured objects in order to be able to typedef the parameter of the inner type in combination with the use of _shared_read/_shared_write parameters and variables. Table 9 below shows an example of programming code that can implement the use of typedefs in combination with _shared_read/_shared_write parameters and variables.

TABLE 9

| | |
|---|---|
| (1) | typedef ... T; |
| (2) | Void f(_shared_read T a, T b) { ... } |

In some implementations, the view modifiers are not included in typedefs because this would allow the view modifiers to be implicitly added to the inner types of container/structured objects. The implicit addition of the view modifiers to the inner types of container/structured objects may not be desired.

A conversion from a normal object to a _shared_read/shared-write object view is done implicitly in order to have a seamless integration when calling a function with view modifiers (view modified parameters). An example of programming code that can implement the implicit conversion is shown below in Table 10.

TABLE 10

| | |
|---|---|
| (1) | Void f(_shared_read T a, T b) { |

| | |
|---|---|
| (2) | ... |

| | |
|---|---|
| (3) | } |
| (4) | Void g( ) { |

| | |
|---|---|
| (5) | T x; |
| (6) | f(x, x); |

| | |
|---|---|
| (7) | } |
| (8) | _shared_read T h( ) { |

| | |
|---|---|
| (9) | T x; |
| (10) | return x; |

| | |
|---|---|
| (11) | } |

In some implementations, removal of a view modifier is accomplished explicitly using a type construction which performs a deep removal of the view modifier. An example of programming code that can implement the removal of a view modifier is shown below in Table 11.

TABLE 11

| | |
|---|---|
| (1) | _shared_read T x = ...; |
| (2) | T y = T(x); |

In some implementations, a first object which is referenced by a view object can be defined at the creation time of the view object. In the case of container/structured types (e.g. Tuple), the view object may continue to reference the first object from a component even after a new object is assigned to the component. An example of programming code that can implement these references is shown below in Table 12.

TABLE 12

| | |
|---|---|
| (1) | Tuple<Column<Int32> “A”> tuple = ...; |
| (2) | _shared_read Tuple<Column<Int32> “A”> view_tuple = tuple; |
| (3) | _shared_read Column<Int32> view_column = view_tuple.“A”; |
| (4) | |
| (5) | assert(view_tuple.“A” == tuple.“A”); |
| (6) | assert(view_column == tuple.“A”); |
| (7) | |
| (8) | Columnt<Int32> new_column = ...; |
| (9) | tuple.“A” = new_column; |
| (10) | |
| (11) | assert(tuple.“A” == new_column); |
| (12) | assert(view_tuple.“A” == new_column); |
| (13) | assert(view_column != new_column); |
| (14) | |
| (15) | // view_column is now no longer linked to view.“A” or tuple.“A”, |
| | but references the old Column object |

In some implementations, each data type can define the object views it supports (e.g., _shared_read and/or _shared_write views). For example, a Block<Int32> data type may support _shared_read views and _shared_write views. A Block<Bool> data type may support _shared_read views, because _shared_write view semantics, when used with the Block<Bool> data type, may lead to technical race conditions as the data type is internally implemented as a vector of bits which cannot be updated consistently from functions running in parallel.

One or more parameters may be passed to each of the parallel function calls. Table 13 below shows example programming code that illustrates an example of passing parameters to parallel function calls. Example types of parameters can include, but are not limited to, inputs passed by copy where the function called (the callee) receives a deep copy of the parameter, outputs passed by reference where the callee receives an exclusive reference to the output, shared inputs where read-only access is allowed, and shared outputs where limited write operations are allowed.

TABLE 13

| | |
|---|---|
| (1) | Void func1(Block<Double> input, Block<Double>& output) { ... } |
| (2) | Void funct2(Size from, Size to, _shared_read Block<Double> input, |
| (3) | _shared_write Block<Double> output) { ... } |
| (4) | |
| (5) | _parallel { |
| (6) | func1(blockA, blockB); |
| (7) | func2(0, blockA.getSize( ) / 2, blockA, blockC); |
| (8) | func2(blockA.getSize( ) / 2, blockA.getSize( ), blockA, blockC); |
| (9) | } |

To ensure safe parameter passing, parameter passing can be implemented using synchronous steps that can evaluate parameter expressions, create copies of the parameter, and aggregate the output for partitioning. Parameter allocation can be on a stack (e.g., as a type Double, Timestamp, etc.) and the pointer to the stack can be passed to the parallel function calls. Parameter allocation can be by a synchronized allocator (e.g., as a type Block, Column, etc.) and the pointer to the location of the parameter can be passed to the parallel function calls. Parameter allocation can utilize an in-thread allocator (e.g., as a type String, Tuple, etc.) where a copy of the parameter is provided to the allocator of the callee.

In order to avoid race conditions, parameter passing to parallel function calls is checked to make sure that a calling function does not pass two arguments to the function calls that point to the same object and/or the same part of memory. This effectively provides an aliasing check. An exception to the checks, where a calling function can pass two arguments to parallel function calls that point to the same object and/or the same part of memory, involve explicit sharing of the arguments as declared by a shared modifier (_shared_read, _shared_write and _shared_readwrite).

The check can use one or more rules when performing the check. For example, arguments passed by reference to a calling function may occur only once in parallel function calls. For example, arguments passed by a shared modifier can occur several times in parallel function calls with the same shared modifier. For example, arguments can be passed by value if passing by value performs a deep copy of the argument. For example, arguments which may have hidden aliases (e.g., an internal reference to other objects, which themselves may be referenced from somewhere else) can only be passed by a _shared_read view.

The parameter passing check can be performed in two steps. During compile-time, parameter passing is checked to see if the same argument (variable) is passed more than once violating any of the above rules. During runtime, parameter passing is checked to see if the same pointers are passed more than once violating any of the above rules. In some implementations, in order to optimize computing system performance, only references to objects of the same type are checked against each other.

Pass by reset (passmode_reset) can be a variation of passing a reference to data for use by parallel tasks (a pass by reference). For example, in a pass by reset the argument to be passed is, by default, initialized during the passing of the argument. The initializing of the argument to be passed during the passing of the argument ensures that no hidden aliases can exist. The callee can have exclusive access to the passed object. The initializing of the argument to be passed during the passing of the argument can be used when passing parameters that are meant for output only. An argument passed in a pass by reset may occur once in a parallel function call. In addition, a pass by reset can be used to return objects that may have hidden aliases (e.g. tables) that cannot be passed by reference.

In some implementations, arguments can be passed by reference to dynamic partitioned calls. In these implementations, each partitioned call can receive a default constructed object of a formal parameter type. After all partitioned calls return, each object returned from a partitioned call is merged into the actual argument by calling a merge method of the actual argument. Example programming code in Table 14 below shows output parameter merging in dynamic partitioning.

TABLE 14

| | |
|---|---|
| (1) | Void f(Block<Int32> fa, Block<Int32> & fb, PartitionInfo info) { |
| (2) | ...; |
| (3) | } |
| (4) | Void h( ) { |
| (5) | ... |
| (6) | parallel::partitionedInvoke(config, f, a, b); |
| (7) | } |
| (8) | The code in lines (1) to (8) above translates into the code in lines |
| | (9) to (16) below. |
| (9) | _parallel { |
| (10) | f(a, b0 = Block<Int32>( ), info(config, 0); |
| (11) | ... |
| (12) | f(a, bn = Block<Int32>( ), info(config, n); |
| (13) | } |
| (14) | b.merge(b0); |
| (15) | ... |
| (16) | b.merge(bn); |

In some implementations, exceptions thrown from parallel function calls can be caught and handled in a way similar to the catching and handling of exceptions thrown from non-parallel function calls. For example, referring to the example programming code in Table 15 below, an exception which occurs in the function f( ) (Table 15, line 11) or an exception that occurs in the function g( ) (Table 15, line 12) can be caught in the function h( ) (Table 15, line 7).

TABLE 15

| | |
|---|---|
| (1) | Void f(Int32 fa, Int32 & fb) { |
| (2) | fb = ... |
| (3) | } |
| (4) | Void g(Int32 gc, Int32 & gd) { |
| (5) | gd = ... |
| (6) | } |
| (7) | Void h( ) { |
| (8) | ... |
| (9) | try { |
| (10) | _parallel { |
| (11) | f(a, b); |
| (12) | g(c, d); |
| (13) | } |
| (14) | } catch (Exception::Arithmetic) { |
| (15) | ... |
| (16) | } |
| (17) | ... |
| (18) | } |

Execution of parallel function calls can be non-deterministic. For example, in the example programming code shown in Table 15 above, there is no ordering between the calls to the function f( ) and the function g( ). In dealing with exceptions, there is no guarantee that a specific function call is executed. For example, if an exception occurs in the function g( ) which is not caught in the function g( ), then the function f( ) may not be called.

In addition, the selection of exceptions can be non-deterministic. For example, if an exception occurs in the function f( ) and the function g( ), which exception is propagated to the calling function (the function h( ) may not be determined. On a first execution of the function h( ), an exception may have occurred in the function f( ) while on a second execution of the function h( ), an exception may have occurred in the function g( ). If multiple exceptions are pending and at least one exception is considered a fatal exception, then the fatal exception is selected. In cases where there may be multiple fatal exceptions, the selection of an exception is non-deterministic.

Table 16 below shows a call hierarchy for a parallel call (e.g., an L programming language call to a C++ programming language call to an L programming call).

TABLE 16

| | |
|---|---|
| (1) | Caller thread |
| (2) | + L-caller (written by L programmer) |
| (3) | + call code (generated by code generator or executed by |
| | interpreter) |
| (4) | + |
| (5) | + Parallelization Framework (C++ library) |
| (6) | |
| (7) | Callee thread |
| (8) | + Parallelization Framework (C++ library) |
| (9) | +ParallelJob.run( ) (C++ class library) |
| (10) | + Export wrapper of L-callee (generated by code generator) |
| (11) | + L-callee (written by L programmer) |

The design of parallel L programming language function calls that manage data sharing and parallelization can include a number of tasks. The tasks can include, but are not limited to, evaluating arguments of all involved function calls, performing an aliasing check for pointers, deciding about a degree of parallelization, creating and filling an argument array, creating and deleting of a runtime context, creating parallel jobs ( ) fetching and post processing results from an argument array, and checking for exceptions.

In some implementations, the arguments of the function calls can be evaluated before the first function call is executed. For example, pointers that are passed to the callees (either as a parameter or as a contained value inside a parameter) are checked to determine if the pointers occur multiple times. A pointer may occur multiple times if it has a “_shared_read” property, or a “_shared_write” property. Any other multiple occurrences of a pointer (including any mixture of “_shared_read”, “_shared_write” and without a sharing property) can lead to a runtime error.

An aliasing check for pointers can include transitively collecting the pointers from the passed parameters, grouping the pointers by compatible types (only pointers of compatible types can be aliases of each other), and checking within each group for aliases. Depending on the object type different kinds of checks may be required. For example, object types that may have hidden aliases (i.e. complicated interdependencies among objects that cannot be easily tracked at language level) are only allowed as “_shared_read”. Objects potentially aliasing other objects can be passed to parallel function calls as read-only parameters. In addition, an aliasing check can include making sure that the same object is not passed to parallel function calls in different access modes or levels.

Enforcing the data sharing access levels declared for the parameters of the parallel function calls can ensure the safety of lock-free access to data when the parallel functions access the same data. Enforcing the data sharing access levels declared for the parameters of the parallel function calls can include enforcing one or more data sharing access rules.

For example, a first rule can be that if multiple references to a data object are passed to multiple parallel function calls, all of the references will have the same data sharing access level (e.g., all of the references will have an exclusive access level). A reference to a first data object may be passed to a parallel function call directly as a parameter, and, in some cases, a reference to a first data object may be passed to a parallel function call indirectly by passing a second data object that includes a reference to the first data object. In some cases, a reference to a first data object may be passed to a parallel function call in other ways that enable parallel function to access the first data object.

For example, a second rule can be that if a data object is passed by an exclusive reference to a parallel function call, no other parallel function call may be passed a reference to the same data object.

For example, a third rule can be that a shared data object can be passed to parallel function calls only using explicit parameters (e.g., a shared data object cannot be passed to parallel function calls using global variables).

Having multiple references to a data object, where the references are in the form of variables or references from other objects, can be generally referred to as aliasing. For example, an alias can be a reference to a data object that can be potentially shared (i.e. there can be other references to the same data object).

In order to comply with the three rules discussed above, in some implementations, programming code written in and compiled for the L programming language complies with the example third rule discussed above because the compiled L code does not support the passing of global variables to function calls and, in general, the L programming language supports functions that are free of any side-effects. In order to comply with the above described example first and second rules, the parameters passed to each parallel function call are checked to see if the parameter passing complies with the above described first and second rules. The checking of the compliance of the passing of a parameter to a parallel function call with the above described first and second rules can be referred to as alias checking.

For example, alias checking can collect each alias to a data object that is directly or indirectly passed as a parameter to a parallel function call, and check that the alias complies with the above described rules. If an alias to a data object passed to a parallel function call is passed as an exclusive reference to the data object then, in compliance with the second rule, no other alias to the same data object can be passed to any other parallel function calls. If an alias to a data object passed to a first parallel function call is passed as a shared reference to the data object (e.g., a shared read access level, a shared write access level, or a shared-read-write access level) and if there are other aliases to the same data object passed to other parallel function calls then, in compliance with the first rule described above, the other aliases to the same data object must be passed to the other parallel function calls with the same sharing level as the alias to the data object passed to the first parallel function call.

The ability to check references to a data object that are passed to parallel function calls can depend on how the data object is aliased. For example, when using the L programming language, the aliasing behavior of the data object can be characterized by the data object's type. For example, one or more categories of L programming language data types can be identified based on the data type's aliasing behavior. The one or more categories can be referred to as aliasing types.

A first aliasing type can be referred to as a value type. A value type data object is copied when assigned to a variable or is inserted into another data object. The aliasing of a value type data object is accomplished by passing the data object to a parallel function call by reference. Therefore, aliases of value type data objects are function parameters with by-reference passing mode. Examples of value type data objects can include, but are not limited to, typical scalar object data types, such as numbers, strings, and date/time objects.

A second aliasing type can be referred to as an atomic reference type. An atomic reference type can be aliased by variables or by references from other data objects. An atomic reference type data object is considered atomic because the atomic reference type data object may not include aliases to other data objects. In the L programming language, Block<T> is an example of an atomic reference type, where Block<T> describes an array of data objects of type T. The data objects included in the Block are not aliased (i.e. they are always deep copied when inserted into a block or extracted from a block, therefore the block may not include aliases to other data objects).

A third aliasing type can be referred to as a composite type. Composite type data objects can include aliases to other data objects. A composite data type object can be identified as a static data object or a dynamic data object. The identity of the data object as static or dynamic is sufficient to traverse over all aliases directly or indirectly included in the composite type data object. An example of a composite type data object in the L programming language can be Tuple<T1, . . . Tn>, which describes a tuple that includes data objects of types T1, . . . Tn.

A fourth aliasing type can be referred to as a hidden type. Hidden type data objects can include aliases to other data objects. In contrast to composite type data objects, the identity of a data object as a static data object or a dynamic data object is not sufficient to traverse over all aliases directly or indirectly included in the hidden type data object. An example of a hidden type data object in the L programming language can be Column<T>, which describes a database column with elements of type T. Columns in a database may be implemented in multiple different ways. Some of the ways in which the columns may be implemented can define non-trivial relationships among the columns. For example, one column can be defined as a view over other columns. The type of information and the runtime properties of the columns exposed to the L programming language may not be sufficient for reliable traversal over all aliases directly or indirectly included in the column.

When collecting all aliases to data objects that are passed to a parallel function call, for value type data objects and atomic reference type data objects, the actual parameters are considered. For composite type data objects, all aliases included in the composite type data object are also considered.

It may be difficult to collect aliases included in hidden type data objects. Because of this difficulty, in some implementations, hidden type data objects may not be passed to parallel function calls. In other implementations, hidden type data objects may be passed to parallel function calls as read-only (i.e. with a shared read access level). For example, one or more database columns can be passed to parallel function calls as read-only (i.e. with a shared read access level). Even if the identities of the columns that are referenced by a first column are not passed as parameters to the parallel function call, passing the one or more database columns as read-only complies with the previously described first and second data sharing access rules. The restricting of the supported sharing access level for hidden type data objects can also be applied to other data objects that may include references to the hidden type data objects. For example, a table in the L programming language can include multiple columns. The passing of tables as parameters to parallel function calls, therefore, is also restricted to a shared-read access level.

In some cases, even if a data object is considered to be a hidden type data object, there may be specific instances of the data object that are without hidden aliasing. For example, newly created data objects of most types are not aliased. Passing a newly created data object to a parallel function call can ensure that the parallel function call receives an exclusive reference to the data object.

In order to support hidden type data objects as output parameters, for example, code for the L programming language passes newly created data objects at the exclusive access level. In function signatures, the output parameters can be annotated with a _reset modifier. The _reset modifier indicates that a variable passed to a parallel function call as a parameter is automatically reset to its default value before the parallel function call. The default value can be a new data object created by the default constructor of the respective data type for the data object. This ensures that the original value of the variable, which may include hidden aliases, is not passed to the parallel function call. Instead the parallel function call receives an exclusive reference to a newly created data object that can safely be used as an output parameter.

Code written in the L programming language can implement various optimizations to alias checking that can reduce a number of required runtime checks, or, in some implementations, the runtime checks may be eliminated.

For example, a first optimization can be based on grouping all aliases by their types (e.g., one or more alias type groups). Aliases of incompatible types may not refer to the same data object, and, therefore, are not compared at runtime. If an alias type group includes a single alias (i.e. a single data object of the alias type is passed) or if all aliases included in the alias type group are passed at the same sharing access level, then a runtime check is not needed for the aliases included in the alias type group.

For example, a second optimization can be based on analyzing aliasing at the parameter expression level. If two parameter expressions evaluate to the same value at runtime, then a first data sharing access rule violation and a second data sharing access rule violation may be detected when the programming code is compiled. For example, the error of passing the same variable using multiple parameters with different data sharing access levels can be detected when the programming code is complied.

If two parameter expressions evaluate to different data values at runtime, there is no need to check the two parameters against each other at runtime. For example, two different local variables reference value type data objects. Because the two different local variables each reference value type data objects, the two different local variables cannot alias the same object. Therefore, the two parameters (the two different local variables) do not need to be check against one another at runtime.

A decision about a degree of parallelization can include determining task parallelization where each function call is transferred into a separate job. Data parallelization can be dependent on a partition configuration and load information from a job executor framework, where the actual number of partitions (and thereby the number of jobs) is determined.

For each callee an argument array can be created and filled. For parameters passed by value, the argument is copied. For parameters passed by reference, a shared_read or a _shared_write pointer to an argument is passed to the callee. In cases where the same object is passed by value and passed by reference to a callee, the copy for the passed by value is performed before the thread of the callee starts.

In some implementations, each callee may need its own runtime context. This is due to, for example, the use of a separate stack trace or the use of a separate temporary allocator. These runtime contexts can share the same global allocator. Since output arguments (passed by reference or passed by a _shared_write) may be allocated with the temporary allocator of the runtime context, the runtime contexts of the callees need to be active (live) for as long as the argument array is passed from/to the callee.

For each parallel function call, a job node is created and passed to a parallelization framework. The parallelization framework can handle the parallel execution of the functions (e.g., scheduling, starting of threads, waiting for thread termination).

All output arguments that have been allocated with the temporary allocator of the runtime context of the callee can be copied into the temporary allocator of the runtime context of the caller. In addition, if an argument has been allocated in the temporary allocator, the argument can be derived from its type. In cases of data parallelization, the output arguments of the different calls can be joined.

Exceptions can be checked for each callee to determine if an exception occurred and if the exception should be propagated to the caller. In addition, before a parallel function call, pending return code checks can be executed.

The design of parallel L programming language function calls that manage data sharing and parallelization also need to take into consideration which tasks are handled where in the call hierarchy. To begin, tasks that are already handled in the generated code for an application should remain as such. The identified affected tasks are an evaluation of arguments and filling of an argument array.

Type-dependent activities can be performed in generated code because the types (e.g., data types) are known at code generation time making it relatively easy to generate type-dependent code. In contrast, when using C++ code the types are only known at runtime and would require switch-case or virtual calls to handle type-dependencies in C++ code. The affected tasks for type-dependent activities can include, but are not limited to, aliasing checks for pointers and fetching and posting processing results from argument arrays.

The components of an implementation of L programming code for data sharing and parallelization can include a structure for call information, an L programming language job executor node, built-in class library functions, and call code.

For example, a structure for call information can be used to transfer information for one callee between generated code/interpreter and C++ built-in class library functions. Table 17 below shows an example structure defined as an LLVM compiler infrastructure and C++ data structure.

TABLE 17

| | |
|---|---|
| (1) | struct CallInfo { |
| (2) | RuntimeContext* m_ctx; |
| (3) | void* m_calleeFctPtr; |
| (4) | void** m_args; |
| (5) | LlangRetumCode m_rc; |
| (6) | } |

Table 18 below shows example programming code for an implementation of a job executor node that encapsulates an L programming language callee.

TABLE 18

| | |
|---|---|
| (1) | class LParallelJob: public ParallelizationNode { |
| (2) | public: |
| (3) | ForeignPtr<CallInfo> m_callInfo; |
| (4) | CallInfo(CallInfo* callInfo); |
| (5) | virtual void run( ); |
| (6) | } |

Built in class functions can include, but are not limited to, Size _getNumberOfPartitions(const PartitionConfig* config) nothrow; CallInfo* _allocateCallInfoArray(RuntimeContext ctx, Size numCalls); Void _doParallelCall(RuntimeContext ctx, Size numCalls, CallInfo* calls); and Void _deallocateCallInfoArray(RuntimeContext ctx, Size numCalls, CallInfo* calls);

Table 19 below shows example pseudo programming code for a function call (call code).

TABLE 19

| | |
|---|---|
| (1) | // evaluate arguments |
| (2) | for each called function |
| (3) | evaluate arguments |
| (4) | end for each called function |
| (5) | |
| (6) | // alias pointer check |
| (7) | for each argument |
| (8) | if pointer |
| (9) | collect pointer, typeinfo |
| (10) | if contains pointer |
| (11) | collect contained pointer, typeinfo |
| (12) | endif contains pointer |
| (13) | endif pointer |
| (14) | end for each argument |
| (15) | group collected pointer, typeinfo by typeinfo |
| (16) | for each group |
| (17) | Search for duplicate pointer in group (with different or no |
| | sharing property) |
| (18) | if duplicate found |
| (19) | throw Exception |
| (20) | end for each group |
| (21) | |
| (22) | // decide about degree of parallelization |
| (23) | if taskParallel |
| (24) | numCalls = numberOfCallNodes |
| (25) | else // dataParallel |
| (26) | numCalls = _getNumberOfPartitions(config) |
| (27) | endif |
| (28) | |
| (29) | callInfoArr = _allocateCallInfo(numCalls) |
| (30) | for each call |
| (31) | currentArgArray = callInfoArr[currentCall].m_args |
| (32) | fill currentArgArray from argument expressions |
| (33) | end for each call |
| (34) | |
| (35) | _doParalelCall(numCalls, callInfoArr); |
| (36) | for each call |
| (37) | currentArgArray = callInfoArr[currentCall].m_args |
| (38) | if taskParallel |
| (39) | transfer output arguments from currentArgArray into |
| | argument expressions |
| (40) | else // dataParallel |
| (41) | join output arguments from currentArgArray into |
| | argument expressions |
| (42) | endif |
| (43) | end for each call |
| (44) | |
| (45) | _deallocateCallInfo(numCalls, callInfoArr) |

Table 20 shows example programming code for a _doParallelCall(ctx, numCalls, callInfoArr) function.

TABLE 20

| | |
|---|---|
| (1) | Create Parallelization |
| (2) | for each call |
| (3) | create LParallelJob(callInfoArr[currentCall].m_args |
| (4) | add LParallelJob to Parallelization graph |
| (5) | end for each call |
| (6) | try { |
| (7) | Execute Parallelization |
| (8) | Wait until Parallelization graph finish |
| (9) | } catch Parallelization exception { |
| (10) | ReturnCode = Fatal_ParallelExecutionFailure |
| (11) | } catch L exception { |
| (12) | // determine L return code |
| (13) | for each LParallelJob |
| (14) | if LParallelJob.m_callInfo->m_rc is fatal |
| (15) | ReturnCode = LParallelJob.m_callInfo->m_rc |
| (16) | FailingParallelJob = LParallelJob; |
| (17) | break; |
| (18) | else if LParallelJob.m_callInfo->m_rc != ok and |
| | ReturnCode == ok |
| (19) | ReturnCode = LParallelJob.m_callInfo->m_rc |
| (20) | FailingParallelJob = LParallelJob; |
| (21) | endif |
| (22) | } |
| (23) | ctx->appendCallStack(FailingParallelJob.m_ctx-> |
| | getStackTrace( )) |
| (24) | } |
| (25) | delete Parallelization |
| (26) | delete LParallelJobs |

Table 21 shows example programming code for a LParallelJob_run( ) function.

TABLE 21

| | |
|---|---|
| (1) | ReturnCode = m_callInfo->m_calleeFctPtr(m_callInfo->m_ctx, |
| | m_callInfo->m_args) |
| (2) | if RetunCode != ok |
| (3) | throw L exception |
| (4) | endif |

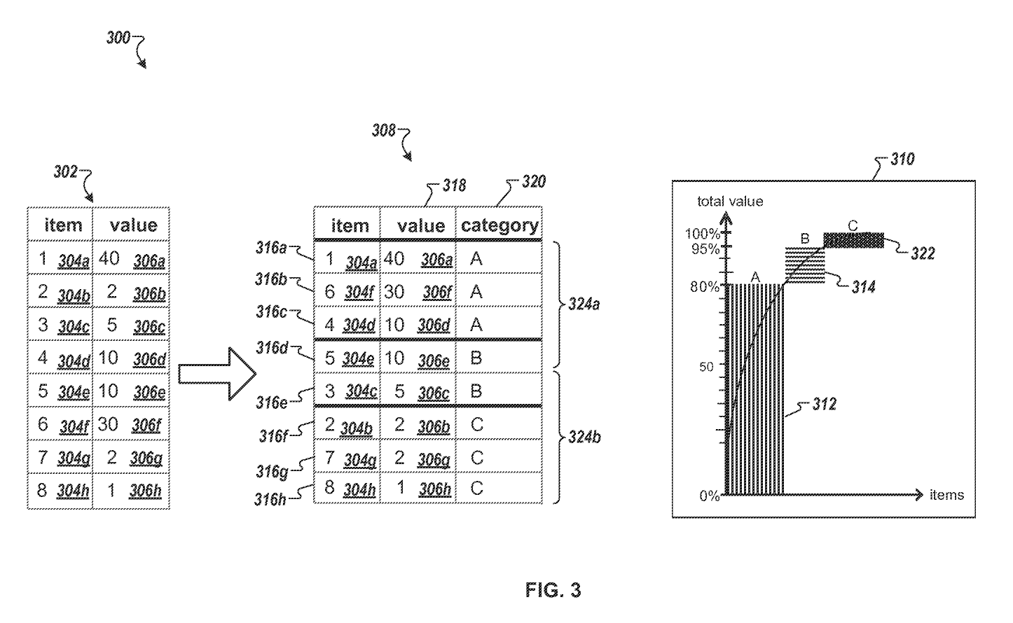

FIG. 3 is an example block diagram 300 showing an example usage of data sharing and parallelization. The diagram 300 shows a first table 302 where eight items 304a-h are each associated with a respective value 306a-h. For example, each item 304a-h can be a customer for an enterprise and each associated respective value 306a-h can be representative of revenue for the enterprise contributed by the customer. Referring to FIG. 1, the first table 302 can be included in the database 116. An algorithm can characterize the items 304a-h into one of three categories: category A, category B, and category C based on their importance.

For example, criteria used to categorize the items may be the placing of all of the high-valued items, which make up 80 percent of the total value of the items, into category A. For example, category A can include the customers that contribute 80% of the total revenue of the enterprise. Category A can be considered the most important category. A second table 308 shows the eight items 304a-h, their respective values 306a-h, and the category that are placed into (category column 320). Referring to FIG. 1, the second table 308 can be included in the memory 114.

For example, the revenue of customers 1, 6, and 4 (items 304a, 304f, and 304d, respectively) accounts for 80% of the total revenue of the enterprise. Customers 1, 6, and 4 (items 304a, 304f, and 304d, respectively) are placed in category A. The revenue of customers 5 and 3 (items 304e and 304c, respectively) accounts for 15% of the total revenue of the enterprise. Customers 5 and 3 (items 304e, and 304c, respectively) are placed in category B. The revenue of customers 2, 7, and 8 (items 304b, 304g, and 304h, respectively) accounts for 5% of the total revenue of the enterprise. Customers 2, 7, and 8 (items 304b, 304g, and 304h, respectively) are placed in category C. The total of the revenue contributed by the customers in each of the categories A, B, and C is the total revenue for the enterprise. A graph 310 shows the contribution of each category to the total value of all of the items (to the total revenue for the enterprise).

In an example that executes programming code that serially operates on the revenue data, an algorithm can sort the data included in the first table 302 on the basis of revenue. For example, the algorithm can generate second table 308 which sorts the data included in the first table 302 based on decreasing revenue. The algorithm can determine a total revenue value for the enterprise (the total value of all the items 304a-h (the sum of the values 306a-h)). The algorithm can then calculate a value for 80 percent of the total revenue (80 percent of the total value of the items 304a-h) and a value for 95 percent of the total revenue (95 percent of the total value of the items 304a-g). The algorithm can loop through the data included in a first value column 318 in descending order of revenue (starting at a first table entry 316a) and can cumulatively sum the sorted values (e.g., add value 306f for a second table entry 316b to value 306a, add value 306d for a third table entry 316c to the sum of the values 306a and 306f, etc.) in order to determine the items (customers) responsible for 80 percent of the total revenue for placement into category A, and the items (customers) responsible for 95 percent of the total revenue (the additional items beyond the items responsible for 80 percent of the total revenue, the additional items (fourth table entry 316d and fifth table entry 316e) placed in category B). The remaining items (sixth, seventh, and eighth table entries 316f-h, respectively) are responsible for five percent of the total revenue that, when included with the items responsible for 95 percent of the total revenue, accounts for all of the items that contribute to the total revenue for the enterprise. The additional items responsible for five percent of the total revenue are placed into category C.

In addition, the algorithm can determine a database index where the 80 percent of the total revenue value is crossed (e.g., the database index for the fourth table entry 316d), and a database index where the 95 percent of the total revenue value is crossed (e.g., the database index for a sixth table entry 316f).

A graph 310 shows the number of items along an x-axis and a percent of the total revenue along a y-axis. Bar 312 represents category A, bar 314 represents category B, and bar 322 represents category C.

In another example, data sharing and parallelization can use a partitioned algorithm in order to characterize the items 304a-h into category A, category B, or category C based on their importance. A sorting algorithm can sort the data included in the first table 302 on the basis of decreased revenue, generating the second table 308. The sorting algorithm can determine a total revenue value for the enterprise (the total value of all the items 304a-h (the sum of the values 306a-h)). The sorting algorithm can calculate a value for 80 percent of the total revenue (80 percent of the total value of the items 304a-h) and a value for 95 percent of the total revenue (95 percent of the total value of the items 304a-g). In some cases, the sorting algorithm can be separate from (different than) the partitioned algorithm. In some cases, the sorting algorithm can be part of the partitioned algorithm. In these cases, the sorting algorithm can be a single process that operates on all of the data included in the second table 308.

The partitioned algorithm can operate in parallel on partitions of the data in the second table 308. For example, referring to FIG. 1, the partitioned algorithm can use the processor 112a and the processor 112b to run a first process and a second process, in parallel, on a first data partition 324a and a second data partition 324b, respectively. The first data partition 324a includes table entries 316a-d and the second data partition 324b includes table entries 316e-h. In parallel, the first process loops through the data included in the first data partition 324a and the second process loops through the data included in the second data partition 324b, each process looping through the data in descending order of revenue. The first process starts at the first table entry 316a while, in parallel, the second process starts at the fifth table entry 316e. Each process cumulatively sums the sorted values in each partition to determine the total revenue for all customers included in the partition.

The total revenue for all customers included in a partition can be considered a portion of the total revenue of all customers for the enterprise. For example, the first process adds value 306f for the second table entry 316b to value 306a (the value for the first table entry 316a), then adds value 306d for the third table entry 316c to the sum of the values 306a and 306f, and so on. In parallel, the second process adds value 306b for the sixth table entry 316f to value 306c (the value for the fifth table entry 316e), then adds value 306g for a seventh table entry 316g to the sum of the values 306c and 306b, and so on. The partitioned algorithm propagates and merges each portion of the total revenue calculated by each process in order to determine the items (customers) responsible for 80 percent of the total revenue for the enterprise, the items (customers) responsible for 95 percent of the total revenue (the incremental items responsible for 15 percent of the total revenue above the 80 percent), and the incremental items responsible for five percent of the total revenue above the 95 percent. For example, the partitioned algorithm determines that the values included in table entries 316a-d account for over 80 percent of the total revenue but less than 95 percent of the total revenue. The partitioned algorithm determines a database index where 80 percent of the total revenue is crossed (e.g., the database index for the fourth table entry 316d). The partitioned algorithm merges and propagates the values for the data included in the second data partition 324b with the data included in the first data partition 324a to determine a database index where 95 percent of the total revenue is crossed (e.g., the database index for the sixth table entry 316f).

In summary, in parallel and on partitions of the data, the partitioned algorithm can, in parallel, loop through partitions of the first value column and sum up the values of the data in each partition. The partitioned algorithm can merge and propagate the partial total values. The partitioned algorithm can scan the data partitions to calculate a value for 80 percent of the total value of the items and a value for 95 percent of the total value of the items. The partitioned algorithm can propagate and merge the data values in each partition in order to determine an index for the value for the 80 percent of the total value of the items and in order to determine an index for the value for 95 percent of the total value of the items. The partitioned algorithm can create a result column 320 that categorizes each item into a category.

Though the example of the partitioned algorithm described with reference to FIG. 3 includes the use of two processors, two parallel processes, and two partitions, in some implementations more than two processors, processes, and partitions may be used in order to perform one or more parallel processes on data included in a database. In these implementations, as in the implementation described with reference to FIG. 3, the data is sorted in order of decreased revenue and placed in a table (e.g., second table 308). Each data partition includes a portion of the data in order of decreased revenue. Parallel processes calculate partial total revenue values for each partition.

In some implementations, for example, in order to determine the data partition where 80 percent of the total revenue is reached or exceeded, the portion of the total revenue calculated for one partition (e.g., a first partition) is propagated to the next partition. An algorithm (either separate from or included in the partitioned algorithm) performs a sequential process of propagating and merging the data. For example, the propagated and merged data from the two partitions is propagated and merged with a third partition. This continues until the total revenue for the merged and propagated data equals or exceeds the value for 80 percent of the total revenue. At this point, the partitioned algorithm can determine that the index for the value for 80 percent of the total revenue is in the last merged partition. This process of propagating and merging of the data partitions continues until the total revenue for the merged and propagated data equals or exceeds the value for 95 percent of the total revenue. At this point, the partitioned algorithm can determine that the index for the value for 95 percent of the total revenue is in the last merged partition.

Another example of data sharing and parallelization can use a partitioned algorithm to implement a data filtering process for a list of numbers included in a block of data. A programmer can create programming code which implements a process that inputs the block of data that includes the list of numbers (e.g., data values included in a first table in a database) and a threshold value. The process can generate and output a block of data (e.g., store data in a second table in a database) that includes resultant values (data values from the first database table (numbers from the list of numbers) that are less than the threshold value). An example of programming code that serially operates on the data (the data values included in the first database table) is shown below in Table 22. The programming code loops through each of the data values in the input block of data sequentially (one at a time), compares the input data value to the threshold value, and if the input data value is less than the threshold value, the input data value is added to (written to) the output block of data.

TABLE 22

| | |
|---|---|
| (1) | Void filterLessThan_sequential(Block<Double>& input, Double |
| (2) | threshold, Block<Double>& output) { |
| (3) | Size size = input.size( ); |
| (4) | // create an output data block with sufficient capacity to hold |
| (5) | // ‘size’ elements |
| (6) | output = Block(size); |
| (7) | // iterate over all the data elements of the input block and add |
| (8) | // to the output data block the elements whose values are less |
| (9) | // than a threshold value |
| (10) | Size i = 0z; // index in the input block |
| (11) | Size j = 0z; // index in the output block |
| (12) | while (i < size) { |
| (13) | if (input[i] < threshold) { |
| (14) | output[j] = input[i]; |
| (15) | j = j + 1z; |
| (16) | } |
| (17) | i = i + 1z; |
| (18) | } |
| (19) | } |

A programmer can create programming code, as shown, for example, in Table 23 below, that uses partitioning and data sharing along with parallelization to perform the data filtering process.

TABLE 23

| | |
|---|---|
| (1) | // Worker function implementing filtering on a partition of a block |
| | of data |
| (2) | Void filterLessThan_part(PartitionInfo info,_shared_read |
| | Block<Double> |
| (3) | input, Double threshold, Block<Double>& partOutput) { |
| (4) | // compute input range based on partition info |
| (5) | Size partSize = input.size( ) / info.partCount( ); // size of |
| (6) | // partition beginning of the range to be processed |
| (7) | Size from = partSize * info.partIndex( ); |
| (8) | // end of the range to be processed |
| (9) | Size to = from + partSize; |
| (10) | // create an output data block with sufficient capacity |
| (11) | partOutput = Block(partSize); |
| (12) | // iterate over all data elements of the input block in the range |
| (13) | // from “from” to “to” and add to the output blocks the data |
| (14) | // elements that are less than a threshold value |
| (15) | Size i = from; // index in the input block |
| (16) | Size j = 0z; // index in the output block |
| (17) | while (index < to) { |
| (18) | if (input[i] < threshold) { |
| (19) | partOutput [j] = input[i]; |
| (20) | j = j + 1z; |
| (21) | } |
| (22) | i = i + 1z; |
| (23) | } |
| (24) | } |
| (25) | |
| (26) | // a parallelized version of filterLessThan |
| (27) | Void filterLessThan_parallel(Block<Double>& input, Double |
| (28) | threshold, Block<Double>& finalOutput) { |
| (29) | PartitionConfig config; // use a default partition configuration |
| (30) | parallel::partitionedInvoke(filterLessThan_part, config, input, |
| (31) | threshold, finalOutput); |
| (32) | } |

In the example programming code shown in Table 23 above, a call to the function parallel::partitionedInvoke( ) creates a number of partitions (parallel processes that each operate on a specific partitioned block of the input data) dependent on the partition configuration passed into the function (e.g., the parameter “config”). In the example programming code shown in Table 23, a default partition configuration is used. When using a default partition configuration, the framework determines the number of partitions automatically dependent on the number of processors included in the system and the current system load. For example, the programming code shown in Table 23 can be integrated into a Job Executor framework included in an in-memory database (e.g., HANA by SAP®).

Alternatively, the programmer can specify a minimum, maximum or exact number of partitions. The framework can assign a different index to each created partition. For each partition and in parallel, an instance of the worker function filterLessThanpart( ) is called. The first parameter of the worker function, “PartitionInfo info”, describes the partition. The “PartitionInfo info” parameter can include two values: the index of the current partition, and the total number of partitions created. Each instance of the worker functionfilterLessThan_part( ) defines the data that is included in the partition defined by the instance of the worker function.

The worker function includes two input parameters, a “_shared_read Block<Double> input” parameter and a “Double threshold” parameter. The input data block (“Block<Double> input”) is passed in a “_shared_read” mode to each instance of the worker function. Passing the input block of data to each instance of the worker function in a “_shared_read” mode allows all of the instances of the worker function to share the input block of data in a read-only mode (each worker function can only read the input block of data), while each instance of the worker function operates on the input block of data in parallel. The “threshold” parameter can be a numerical value that can be passed, by copy, to all instances of the worker function as they operate in parallel. Each instance of the worker function receives access to the entire input data block. Each instance of the worker function can read all of the elements of the input data block independent of the partition defined by the particular instance of the worker function. Each instance of the worker function need not be restricted to access only the partition of the input data block defined by the particular instance of the worker function because accessing shared data in parallel as read-only can be considered safe (only reading the data can avoid any inadvertent data corruption). The framework and/or the programmer can determine the partitioning. In the example programming code shown in Table 23, the index of the current partition and the number of the partitions are used to determine the range of the input data (the “from” and “to”) for processing by each instance of the worker function.

The output parameter of the worker function, “Block<Double>& partOutput” (where the symbol “&” indicates that the output parameter is passed by reference) is not passed in a “_shared_read” or “_shared_write” mode. Each instance of the worker function has full control of the output parameter object (the instance of the worker function can read and write to the particular output block of data defined by the particular instance of the worker function). In the example programming code shown in Table 23, the worker function assigns the output of the function to a newly created output data block. The worker function fills the output data block (writes data into the output data block) with the input data elements that satisfy the threshold criteria (the input data elements whose values that are less than the threshold value). In contrast to the input parameter “_shared_read Block<Double> input” that passes the input block of data to each instance of the worker function in a “_shared_read” mode, the output parameter “Block<Double>& partOutput” is not shared. The parallel::partitionedInvoke( ) function creates a unique output data block for each instance of the worker function and calls each instance of the worker function in parallel. In some implementations, an additional function can take each of the unique output blocks created by each instance of the worker function and merge the contents (the data included in) each unique output data block to generate a single final output data block. The final output data block can include the data elements from the input data block whose values are less than the threshold value.

Creating unique output data blocks for each instance of the worker function does not allow sharing a writeable data block (a data block that includes writeable objects) among parallel processes avoiding any possible race conditions when writing data to the output data block. Creating unique output data blocks for each instance of the worker function involves first creating multiple separate output data blocks and then copying/merging/combining each separate output data block into a single consolidated data block.

This process may be performed more efficiently by allowing each instance of the worker function, running in parallel, access to a single final output data block. Each instance of the worker function can then concurrently write to (fill) the final output data block. Race conditions and possible indeterministic (unpredictable) data can be avoided in cases where the size and the structure of the final output data block is known in advance (i.e. before performing the computation). In the example programming code shown in Table 23, the data filtering process does not know in advance the number of data elements in the input data block whose values are less than the threshold value before the data filtering is performed.

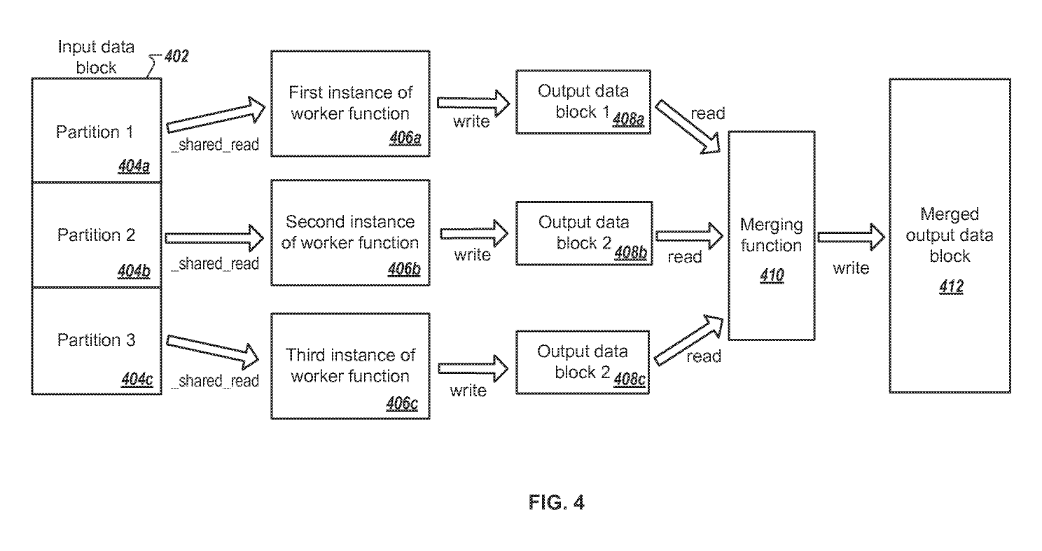

FIG. 4 is a block diagram showing the data filtering process performed by the programming code included in Table 22 and Table 23, above. For example, referring to FIG. 1, the system 100 can perform the data filtering process by executing the programming code. An input data block 402 can include the list of numbers the process can filter. In some implementations, the input data block 402 can be included in the database 116. In some implementations, the input data block 402 can be included in the memory 114 as part of an in-memory database. The system 100 can provide a Job Executor framework included in the in-memory database (e.g., HANA by SAP®). For example, the framework can automatically determine that the system 100 can use three partitions to perform the data filtering process based on the number of processors included in the system 100 and the current system load. In this example, though the system 100 may include more than three processors, the framework determines that three partitions should be used based further on the current load on the system 100. In the alternative, the programmer may specify that the system 100 use three partitions.

The framework partitions the input data block 402 into three partitions, partitions 404a-c, and assigns a different index to each partition 404a-c. Three instances of the worker function 406a-c (e.g., the worker functionfilterLessThan_part( ) in Table 23, above) are executed in parallel and the index for each partition 404a-c is passed into the respective instance of the worker function 406a-c. The input data block 402 is passed to each instance of the worker function 404a-c in a “_shared_read” mode. The three instances of the worker function 406a-c, executing in parallel, can share the input data block 402 in a read-only mode. Executing in parallel, each instance of the worker function 406a-c can write data to respective output data blocks 408a-c. The written data can include data elements from the input data block 402 that are less than a threshold value, where a copy of the threshold value is passed to each instance of the worker function 406a-c. In some implementations, the output data blocks 408a-c can be included in the memory 114. In some implementations, the output data blocks 408a-c can be included in the database 116.

Each instance of the worker function 406a-c can directly control (e.g., read, write) its respective output data block 408a-c. The output data blocks 408a-c are not shared between instances of the worker function maintaining the integrity of the output data. For example, a merging function can have read-only access to the output data blocks 408a-c in order to read the data in each of the output data blocks 408a-c, merge the data, and write the data into a merged output data block 412. In some implementations, the merged output data block 412 can be included in the memory 114. In some implementations, the merged output data block 412 can be included in the database 116. In some implementations, the merged output data block 412 can be the concatenation of the output data blocks 408a-c.

Another example of data sharing and parallelization can use a partitioned algorithm to add two lists of numbers included in a first data block and a second data block, pairwise, where the length of the first data block is equal to the length of the second data block. A programmer can create programming code which implements a process that inputs the first data block and the second data block, adds the elements in each data block pairwise, and writes the sum of the elements into an output data block. For example, the first element of the first data block is summed with the first element of the second data block and the result is written as the first element of the output data block. Continuing, the second element of the first data block is summed with the second element of the second data block and the result is written as the second element of the output data block. This process continues until all of the elements in the equal sized first and second data blocks have been added together and the result written to the output data block.

An example of programming code that serially operates on the data and pairwise sums the elements in a first data block and a second data block is shown below in Table 24.

TABLE 24

| | |
|---|---|
| (1) | Void addPairwise_sequential(Block<Double>& input1, |
| (2) | Block<Double>& input2, Block<Double>& output) { |
| (3) | // the input data blocks are the same size |
| (4) | Size size = input1.size( ); |
| (5) | Size i = 0z; |
| (6) | while (i < size) { |
| (7) | output[i] = input1 [i] + input2[i]; |
| (8) | i = i + 1z; |
| (9) | } |
| (10) | } |

A programmer can create programming code, as shown, for example, in Table 25 below, that uses partitioning and data sharing along with parallelization to perform the pairwise summing of the elements in a first data block and a second data block.

TABLE 25

| | |
|---|---|
| (1) | // Worker function, implementing addition on respective partitions |
| (2) | // of each of the input blocks |
| (3) | Void addPairwise_part(PartitionInfo info,_shared_read |
| (4) | Block<Double> input1,_shared_read Block<Double> |
| (5) | input2,_shared_write Block<Double>output) { |
| (6) | // compute input data range based on partition info |
| (7) | Size partSize = input.size( ) / info.partCount( ); // size of |
| | partition |
| (8) | // beginning of the range to be processed |
| (9) | Size from = partSize * info.partIndex( ); |
| (10) | // end of the range to be processed |
| (11) | Size to = from + partSize; |
| (12) | // iterate over all elements in the range from “from” to “to” |
| (13) | // add the elements pairwise and write their sums at the same |
| (14) | // index in the output data block |
| (15) | Size i = from; // index in the input data block |
| (16) | while (index < to) { |
| (17) | output[i] = input1 [i] + input2[i]; |
| (18) | i = i + 1z; |
| (19) | } |
| (20) | } |
| (21) | |
| (22) | // a parallelized version of addPairwise |
| (23) | Void addPairwise_parallel(Block<Double>& input1, |
| (24) | Block<Double>& input2, Block<Double>& output) { |
| (25) | PartitionConfig config; // use default partition configuration |
| (26) | // create an output data block in advance with the required size |
| (27) | output = Block(input1.size( )); |
| (28) | parallel::partitionedInvoke(addPairwise_part, config, input1, |
| (29) | input2, output); |
| (30) | } |

In the example programming code shown in Table 25 above, a call to the function parallel::partitionedInvoke( ) creates a number of partitions (parallel processes that each operate on a specific partitioned block of the first input data and a specific partitioned block of the second input data, where the partitioned blocks are equal in size) dependent on the partition configuration passed into the function (e.g., the parameter “config”). In the example programming code shown in Table 25, a default partition configuration is used. When using a default partition configuration, the framework determines the number of partitions automatically dependent on the number of processors included in the system and the current system load. For example, the programming code shown in Table 25 can be integrated into a Job Executor framework included in an in-memory database (e.g., HANA by SAP®).

Alternatively, the programmer can specify a minimum, maximum or exact number of partitions. The framework can assign a different index to each created partition. For each partition of the first input block and the second input block, and in parallel, an instance of the worker function addPairwise_part( ) is called. The first parameter of the worker function, “PartitionInfo info”, describes the partition. The “PartitionInfo info” parameter can include three values: the index of the current partition for the first input data block, the index of the current partition for the second input data block, and the total number of partitions created. Each instance of the worker function addPairwise_part( ) defines the data that is included in the partition defined by the instance of the worker function.

The worker function includes three input parameters, a “_shared_read Block<Double> input1” parameter, a “_shared_read Block<Double> input2” parameter and a “_shared_write Block<Double> output” parameter. The first input data block (“Block<Double> input1”) and the second input data block (“Block<Double> input2”) are passed in a “_shared_read” mode to each instance of the worker function. Passing the input blocks of data to each instance of the worker function in a “_shared_read” mode allows all of the instances of the worker function to share the input blocks of data in a read-only mode (each worker function can only read the input blocks of data), while each instance of the worker function operates on the input blocks of data in parallel.

Each instance of the worker function receives access to the entire first input data block and the entire second input data block. Each instance of the worker function can read all of the elements of the input data blocks independent of the partition defined by the particular instance of the worker function. Each instance of the worker function need not be restricted to access only the partition of the input data blocks defined by the particular instance of the worker function because accessing shared data in parallel as read-only can be considered safe (only reading the data can avoid any inadvertent data corruption). The framework and/or the programmer can determine the partitioning. In the example programming code shown in Table 25, for the first input data block and the second input data block, the index of the current partition and the number of the partitions are used to determine the range of the input data (the “from” and “to”) for the first input data block and the second input data block for processing by each instance of the worker function.

The output parameter of the worker function, “_shared_write Block<Double>Output” is passed in a “_shared_write” mode. Each instance of the worker function can concurrently write to an output block of data shared by all instances of the worker function. In the example programming code shown in Table 25, each instance of the worker function determines a range of elements of the output data block to access, the range dependent on the partition index of the particular instance of the worker function. In this example, the range of elements that an instance of a worker function can access does not overlap with elements in the range of elements of the output data block for the other instances of the worker function. No two instances of the worker function need to write data to the same element (at the same position) of the output block concurrently. Race conditions and possible indeterministic (unpredictable) data can be avoided because the size and the structure of the final output data block is known in advance (i.e. before performing the computation).

In some cases, if a programmer introduces an error in the programming code, a race condition may occur where two instances of the worker function concurrently write to the same element in the output data block. Though this may introduce indeterministic data into the output data block, the erroneous race condition may not cause system data corruption or a system crash. Each “_shared” mode of operation (e.g., _shared_read, shared_write, shared_readwrite) limits access to the objects in a block of data to operations that, though they may produce indeterministic data, can be considered safe. The “_shared” modes of operation may allow reading and/or writing of data elements in a data block but do not allow resizing or destroying of the data block. The operations of resizing and destroying of all or parts of the data block can result in system data corruption, and potential system crashes. For example, a first instance of a worker function may delete a particular data block that a second instance of the worker function then attempts to access (e.g., read). In some cases, the second instance of the worker function may read corrupted data. In some cases, the read operation performed by the second instance of the worker function may cause a system crash.

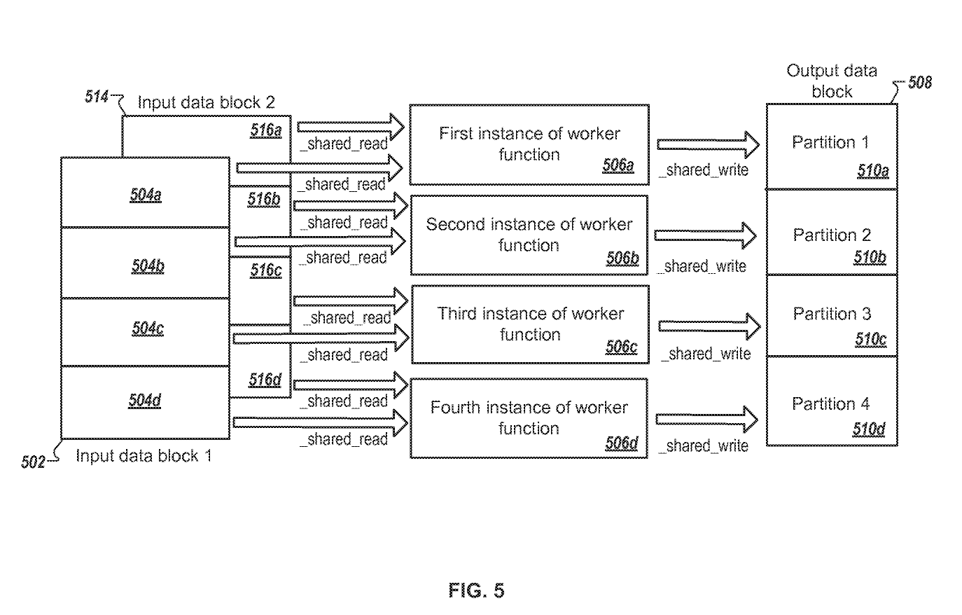

FIG. 5 is a block diagram showing the pairwise summing of elements in a first data block and a second data block performed by the programming code included in Table 24 and Table 25, above. For example, referring to FIG. 1, the system 100 can perform the pairwise summing process by executing the programming code. A first input data block 502 can include a first list of numbers and a second input data block 514 can include a second list of numbers. In some implementations, the input data blocks 502, 514 can be included in the database 116. In some implementations, the input data blocks 502, 514 can be included in the memory 114 as part of an in-memory database. In some implementations, the input data block 502 can be included in the database 116 and the input data block 514 can be included in the memory 114 as part of an in-memory database. In some implementations, the input data block 514 can be included in the database 116 and the input data block 502 can be included in the memory 114 as part of an in-memory database.

The system 100 can provide a Job Executor framework included in an in-memory database (e.g., HANA by SAP®). For example, the framework can automatically determine that the system 100 can use four partitions based on the number of processors included in the system 100 and the current system load. In this example, though the system 100 may include more than four processors, the framework determines that four partitions should be used based further on the current load on the system 100. In the alternative, the programmer may specify that the system 100 use four partitions.

The framework partitions the first input data block 502 into four partitions, first partitions 504a-d, and assigns a different index to each first partition 504a-d. The framework partitions the second input data block 514 into four partitions, second partitions 516a-d, and assigns a different index to each second partition 516a-d. Four instances of the worker function 506a-d (e.g., the worker function addPairwise_part( ) in Table 25, above) are executed in parallel and the index for each first partition 504a-d and the index for each second partition 516a-d are passed into the respective instance of the worker function 506a-d. The first input data block 502 and the second input data block 514 are passed to each instance of the worker function 506a-d in a “_shared read” mode. The four instances of the worker function 506a-d, executing in parallel, can share the first input data block 502 in a read-only mode and can share the second input data block 514 in a read-only mode.

Executing in parallel, each instance of the worker function 506a-d can concurrently write data to a respective output partition 510a-d of an output data block 508. The instances of the worker function 506a-d can share the output data block 508 in a “_shared_write” mode (e.g., each instance of the worker function 506a-d can write data to the output data block 508). The written data can include the pairwise sum of a data element from the first input data block 502 and a data element from the second input data block 514. Each instance of the worker function 506a-d determines a range of elements of the output data block 508 to access. The determined range of elements for each instance of the worker function 506a-d is included in the respective output partitions 510a-d. The range of elements can be dependent on the partition index of the particular instance of the worker function for the output data block 508.

For example, referring to FIG. 5, the first input data block 502, the second input data block 514, and the output data block 508 can include an equal number of data elements (the input data blocks 502, 514 and the output data block 508 are all the same size). The number of data elements (the size of each input data block 502, 514) can be know in advance of any computations. In this example, each input data block 502, 514 is divided into four partitions: first partitions 504a-d and second partitions 516a-d, respectively. Each partition 504a-d and 516a-d is for use by (is accessed by) the respective instance of the worker function 506a-d. The number of elements included in (the size of) the first partitions 504a-d are equal to the number of elements included in (the size of) the respective second partitions 516a-d. For example, the size of first partition 504a is equal to the size of the second partition 516a. In some cases, the elements of the input data blocks 502, 514 may not divide by four equally. One of the partitions may be a different size (e.g., smaller than or larger than) the other partitions. For example, the size of the first data partitions 504a-c may be equal to one another and equal to the size of each of the respective second data partitions 516a-c. First data partition 504d may be equal in size to the second data partition 516d, while the size of data partitions 504d, 516d may be different than (e.g., greater than or less than) the size of the other data partitions 504a-c and 516a-c.

The output data block 508 can also be partitioned into four output partitions 510a-d. The number of elements included in (the size of) each output partition 510a-d is equal to the number of elements included in (the size of) the respective first partition 504a-d and second partition 516a. Each partition 510a-d is for use by (is accessed by) the respective instance of the worker function 506a-d. As an example, the number of elements included in (the size of) the first partition 504a is equal to (the same as) the number of elements included in (the size of) the second partition 516a, which is equal to number of elements included in (the size of) the output partition 510a. Partitions 504a, 516a, and 510a are used by (accessed by) a first instance of the worker function 506a. Maintaining the number of elements included in (the size of) each respective partition the same with respect to both input data blocks 502, 514 and the output data block 508 allows the instances of the worker function 506a-d to access the entire output data block safely in a “_shared_write” mode. The access is considered safe because the range of elements that an instance of a worker function can access does not overlap with elements in the range of elements of the output data block for the other instances of the worker function. In some implementations, overlapping of the range of data elements in the output data block 508 can be avoided by making the size of each partition 510a-d larger than its respective input data block size. This, however, may use additional memory resources.

In some implementations, the output data blocks 508 can be included in the memory 114. In some implementations, the output data block 508 can be included in the database 116.

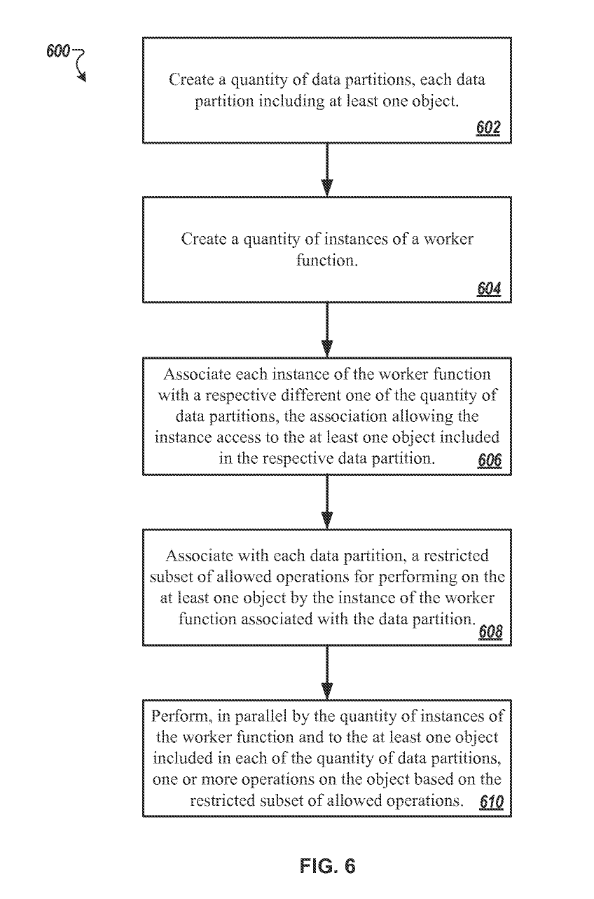

FIG. 6 is a flowchart that illustrates a method 600 for implementing data partitioning and sharing along with parallelization. In some implementations, the method 600 can be implemented by the computing systems and devices described herein.

The method 600 begins by creating a quantity of data partitions, each data partition including at least one object (block 602). A quantity of instances of a worker function is created (block 604). Each instance of the worker function is associated with a respective different one of the quantity of data partitions, the association allowing the instance access to the at least one object included in the respective data partition (block 606). For example, dynamic partitioning in a computing system allows a function (a worker function) to be invoked multiple times (multiple instances are created and executed in parallel) on multiple partitions of data. The worker function can be called once for each partition.

A restricted subset of allowed operations for performing on the at least one object by the instance of the worker function associated with the data partition is associated with each data partition (block 608). One or more operations on the object are performed, in parallel by the quantity of instances of the worker function and to the at least one object included in each of the quantity of data partitions, based on the restricted subset of allowed operations (block 610). For example, the restricted subset of operations provides safe and efficient sharing of data structure among functions that run in parallel and access the data structures.

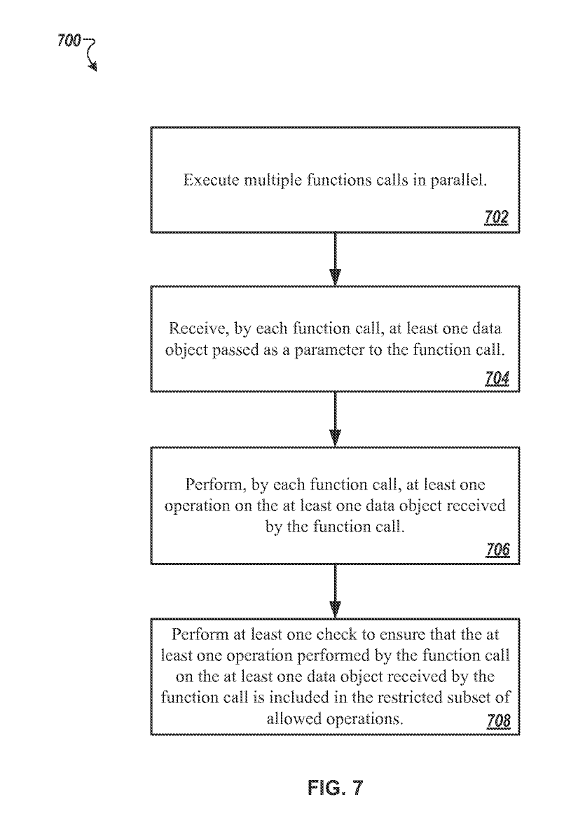

FIG. 7 is a flowchart that illustrates a method 700 for implementing data sharing along with parallelization. In some implementations, the method 700 can be implemented by the computing systems and devices described herein.

The method 700 begins by executing multiple functions calls in parallel (block 702). At least one data object passed as a parameter to the function call, is received by each function call (block 704). The at least one data object can be associated with a data sharing mode that defines a restricted subset of allowed operations for performing by the function call on the at least one data object. At least one operation on the at least one data object received by the function call, is performed by each function call (block 706). The at least one operation can be included in the restricted subset of allowed operations defined by the data sharing mode associated with the at least one data object. At least one check is performed to ensure that the at least one operation performed by the function call on the at least one data object received by the function call is included in the restricted subset of allowed operations (block 708). The restricted subset of allowed operations can be defined by the data sharing mode associated with the at least one data object.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art.

What is claimed is:

1. A method comprising:
executing multiple functions calls in parallel;
receiving, by each function call, at least one data object passed as a parameter to the function call, the at least one data object associated with a data sharing mode that defines a restricted subset of allowed operations for performing by the function call on the at least one data object;
performing, by each function call, at least one operation on the at least one data object received by the function call, the at least one operation included in the restricted subset of allowed operations defined by the data sharing mode associated with the at least one data object; and
performing at least one check to ensure that the at least one operation performed by the function call on the at least one data object received by the function call is included in the restricted subset of allowed operations defined by the data sharing mode associated with the at least one data object.

2. The method of claim 1, wherein the data sharing mode is one of an exclusive access level, a shared read access level, and shared container write access level.

3. The method of claim 2, wherein the data sharing mode is the exclusive access level, and the restricted subset of allowed operations includes a read operation and a write operation.

4. The method of claim 2, wherein the data sharing mode is the shared read access level, and the restricted subset of allowed operations includes a read operation.

5. The method of claim 2, wherein the data sharing mode is the shared container write access level, and the restricted subset of allowed operations includes a container write operation and a metadata read operation.

6. The method of claim 1, wherein the at least one data object passed as a parameter to the function call is initialized during the passing of the parameter.

7. The method of claim 1, further comprising:
creating a quantity of data partitions;
creating multiple instances of a worker function; and
associating each instance of the worker function with a respective different one of the quantity of data partitions, wherein executing multiple functions calls in parallel comprises executing the multiple instances of the worker functions in parallel.

8. The method of claim 7, wherein receiving, by each function call, at least one data object passed as a parameter to the function call comprises receiving, by each instance of the worker function, the at least one data object passed as a parameter to the instance of the worker function from the data partition associated with the instance of the worker function.

9. The method of claim 1, wherein performing at least one check comprises performing an aliasing check, the aliasing check being one of a runtime check or a compile-time optimization.

10. The method of claim 9, wherein performing the aliasing checking comprises checking an alias type associated with an alias, the alias type being one of a value type, an atomic reference type, a composite type, and a hidden type.

11. A computing system including one or more processors, and a computer-readable medium coupled to the computing system having instructions stored thereon which, when executed by the one or more processors, cause the one or more processors to perform operations comprising:
executing multiple functions calls in parallel;
receiving, by each function call, at least one data object passed as a parameter to the function call, the at least one data object associated with a data sharing mode that defines a restricted subset of allowed operations for performing by the function call on the at least one data object;
performing, by each function call, at least one operation on the at least one data object received by the function call, the at least one operation included in the restricted subset of allowed operations defined by the data sharing mode associated with the at least one data object; and
performing at least one check to ensure that the at least one operation performed by the function call on the at least one data object received by the function call is included in the restricted subset of allowed operations defined by the data sharing mode associated with the at least one data object.

12. The system of claim 11, wherein the data sharing mode is one of an exclusive access level, a shared read access level, and shared container write access level.

13. The system of claim 12, wherein the data sharing mode is the exclusive access level, and the restricted subset of allowed operations includes a read operation and a write operation.

14. The system of claim 12, wherein the data sharing mode is the shared read access level, and the restricted subset of allowed operations includes a read operation.

15. The system of claim 12, wherein the data sharing mode is the shared container write access level, and the restricted subset of allowed operations includes a container write operation and a metadata read operation.

16. The system of claim 11, wherein the at least one data object passed as a parameter to the function call is initialized during the passing of the parameter.

17. The system of claim 11, the operations further comprising:
creating a quantity of data partitions;
creating multiple instances of a worker function; and
associating each instance of the worker function with a respective different one of the quantity of data partitions, wherein executing multiple functions calls in parallel comprises executing the multiple instances of the worker functions in parallel.

18. The system of claim 17, wherein the operation of receiving, by each function call, at least one data object passed as a parameter to the function call comprises receiving, by each instance of the worker function, the at least one data object passed as a parameter to the instance of the worker function from the data partition associated with the instance of the worker function.

19. The system of claim 11, wherein the operation of performing at least one check comprises performing an aliasing check, the aliasing check being one of a runtime check or a compile-time optimization.

20. The system of claim 19, wherein the operation of performing the aliasing checking comprises checking an alias type associated with an alias, the alias type being one of a value type, an atomic reference type, a composite type, and a hidden type.
